(19) United States
(12) Patent Application Publication
(10) Pub. No.: US 2002/0017964 A1
(43) Pub. Date: Feb. 14, 2002

(54) Nonreciprocal circuit device and communication device using same

(75) Inventors: Takekazu Okada, Ishikawa-ken (JP); Satoru Shinmura, Kanazawa-shi (JP); Toshihiro Makino, Matto-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/749,317

(22) Filed: Dec. 27, 2000

(30) Foreign Application Priority Data
Dec. 28, 1999 (JP) 11-374865

(51) Int. Cl. H01P 1/32

(52) U.S. Cl. 333/1.1; 333/24.2

(57) ABSTRACT

The present invention provides a nonreciprocal circuit device which allows the inductance component of centeral conductors to be enlarged even when a magnetic body is reduced in the size, and which is thereby capable of achieving superior characteristics over a wide band while having a small size, and further provides a communication device using the same. In this nonreciprocal circuit device, a magnetic body is formed by winding two centeral conductors around a magnetic body having a rectangular-parallelepiped plate shape so as to intersect each other at an angle of substantially 90 degrees. As these centeral conductors, metallic wires constituted of a metallic material such as copper or silver are used, the metallic wires being coated with an insulative resin such as polyester or polyimide.

### BACKGROUND OF THE INVENTION

1. Field of the Invention

The present invention relates to a nonreciprocal circuit device used in the high-frequency band such as the microwave band and to a communication device using the same.

2. Description of the Related Art

The nonreciprocal circuit device is used in communication devices and the like, which take advantage of the characteristics thereof that the nonreciprocal circuit device therein is very small in the attenuation with respect to the transmission direction of a signal, while it is very large in the attenuation in the opposite direction. Conventionally, a two-port type nonreciprocal circuit device is known wherein two centeral conductors are arranged on a ferromagnetic body (ferrite) in an electric insulation state so as to intersect each other at an angle of substantially 90 degrees; one end of each of the centeral conductors is connected to input and output terminals; the other end thereof is grounded; capacitors are each connected between the input and output terminals and a ground; a resistor is connected between the input and output terminals; and a static magnetic field is applied to the magnetic body. Such a construction is considered to allow this two-port type nonreciprocal circuit device to have a smaller size and to have a wider band width where the above-described irreversible characteristics are obtained, than a three-port type nonreciprocal circuit device.

Hitherto, in such a nonreciprocal circuit device, centeral conductors (electrode films) are formed on the surface or the inside of a magnetic body by printing or the like; otherwise, centeral conductors formed on the surface or the inside of a dielectric substrate by printing or the like, are arranged on the magnetic body; alternatively, centeral conductor of metallic foil (conductor plate) are arranged on the magnetic body (see Japanese Unexamined Patent Application Publication No. 11-205016). More specifically, in a conventional two-port type nonreciprocal circuit device, the centeral conductors are arranged only on one of the main surfaces of the magnetic body or only on the other of the main surfaces parallel therewith, without being wound around the magnetic body.

Meanwhile, with the request for a further reduction in the size of recent mobile communication equipment, nonreciprocal circuit devices used for mobile communication equipment are also required to implement a further size-reduction. The input/output characteristic impedance of communication devices or the like is typically designed to be substantially 50 Ω. Generally, the characteristic impedance in the input/output portion of the nonreciprocal circuit device is also designed to be substantially 50 Ω. The characteristic impedance in the input/output portion of the nonreciprocal circuit device is determined by the inductance component which the centeral conductors possess, and the capacitance of a capacitor connected in parallel with the inductance component.

In the above-described conventional arrangement, however, when the nonreciprocal circuit device thereof is reduced in the size, and consequently when the magnetic body is reduced in the size, the length of the centeral conductor is also inevitably decreased, and thereby the inductance component thereof is reduced. Hence, in order to obtain a required characteristic impedance, it is necessary to increase the capacitance value of the capacitor thereof, that is, to increase the size of the capacitor. This results in that the reduction in size is very hard. On the other hand, once the inductance component is reduced, the band width is also narrowed, and thereby desired isolation characteristics and a desired insertion loss can not be achieved in a desired band.

In other words, in the above-described conventional nonreciprocal circuit device, since once the size thereof is reduced, the inductance component of the centeral conductor is decreased, no impedance matching is obtained, and an insertion loss increases in a desired frequency band, that is, no desired characteristics can be achieved. Conversely, when attempting to obtain a desired characteristics, it becomes necessary to use a large-sized capacitor. This raises a problem that the nonreciprocal circuit device can not be miniaturized.

### SUMMARY OF THE INVENTION

Accordingly, it is an object of the present invention to provide a nonreciprocal circuit device which allows the inductance component of the centeral conductors to be enlarged even when the magnetic body is reduced in the size, and which is thereby capable of achieving superior characteristics over a wide band while having a small size, and further to provide a communication device using the same.

In order to achieve the above-described object, the present invention, in a first aspect, provides a nonreciprocal circuit device comprising a magnetic body which receives a DC magnetic field, the magnetic body including a plurality of centeral conductors provided in an electric insulation state. In this nonreciprocal circuit device, the plurality of centeral conductors are insulation-coated metallic wires, and each of the metallic wires is wound around the magnetic body one or more times.

The present invention, in a second aspect, provides a nonreciprocal circuit device comprising a first centeral conductor one end of which is connected to an input terminal, and the other end of which is grounded; a second centeral conductor which intersects the first conductor in an electric insulation state, one end of which is connected to an output terminal, and the other end of which is grounded; a magnetic body including the first and second centeral conductors; a permanent magnet for applying a static magnetic field substantially perpendicularly to the main surfaces of the magnetic body; a first capacitor connected between the input terminal and a ground; a second capacitor connected between the output terminal and the ground; and a resistor connected between the input terminal and the output terminal. In this nonreciprocal circuit device, the first and second centeral conductors are insulation-coated metallic wires, and the metallic wires are wound around the magnetic body one or more times. Preferably, as a material for the metallic wire, copper or silver is used, which is inexpensive. Herein, a winding number is defined in a way such that, when the centeral conductor (metallic wire) is arranged one time by being wound along both main surfaces of the magnetic body, the winding number is one.

In accordance with this arrangement, since the centeral conductors are arranged on the magnetic body by being wound around the magnetic body, the centeral conductors can be extended even when a small magnetic body is employed, and thereby a large inductance component thereof can be obtained. Also, by changing the winding number, a required inductance value can be easily achieved. This allows the capacitor for providing a required characteristic impedance to be reduced in the size, and thereby enables the nonreciprocal circuit device to be miniaturized. Furthermore, since the inductance component can be increased, the band width where the irreversible characteristics are obtained in an operation frequency band can be widen, the insertion loss can be reduced over a wide band, and thus excellent isolation characteristics can be achieved. Moreover, since insulation-coated metallic wires are used, there is no need to separately provide insulators for electrically insulating the centeral conductors, such as insulating sheets, which results in a reduction in the production cost.

In the case of the two-port type nonreciprocal circuit device constituted of two centeral conductors, preferably, the intersecting angle between the first and second conductors is set to be within the range from 80 degrees to 100 degrees, in order to obtain desired isolation characteristics.

By using a magnetic body having a polygonal shape in a plan view, the centeral conductors can be wound orthogonally to each of the sides of the magnetic body, and hence the centeral conductors can be reliably positioned with a high accuracy, and the intersecting angle can be strictly set. This allows a stable and superior characteristics which is low in the variation therein to be achieved. In this case, if a rectangular parallelepiped is selected as a shape of the magnetic body, a magnetic body can be cut out from a large-sized magnetic body substrate without wasting the substrate, which leads to a cost-reduction.

Also, by using a permanent magnet having a rectangular-parallelepiped plate shape, the cost thereof can be reduced as in the case of the magnetic body, and also the magnetic force can be efficiently applied to the magnetic body. This is effective notably when the magnetic body is formed as a rectangular-parallelepiped.

Moreover, by disposing a yoke which shields each of the members and which constitutes a magnetic circuit, on the terminal substrate on which the input terminal, the output terminal and the ground conductor have been formed, and by connecting this yoke to the ground conductor of the terminal substrate to ground, the shielding effect is enhanced.

By adopting the above-described arrangement, e.g., when a magnetic body having a rectangular-parallelepiped plate shape is used, the dimension of the long side thereof can be reduced to 1.0 mm or less. In addition, a nonreciprocal circuit device of 3.5 mm square or less in a plan view can be implemented.

In accordance with a third aspect of the present invention, there is provided a communication device comprising a nonreciprocal circuit device having the above-described features. A small-sized communication device having a superior characteristics can thereby be achieved.

The above object and other objects, features, and advantages of the present invention will be clear from the following detailed description of the preferred embodiments of the invention in conjunction with the accompanying drawings.

### BRIEF DESCRIPTION OF THE DRAWINGS

FIG. 1 is an exploded perspective view showing a nonreciprocal circuit device in accordance with a first embodiment of the present invention.

FIG. 2 is a perspective view showing the nonreciprocal circuit device in accordance with the first embodiment, the nonreciprocal circuit device being rid of an upper yoke and a permanent magnet.

FIG. 3 is a perspective view showing a magnetic assembly in accordance with the first embodiment.

FIG. 4 is a block diagram showing the construction of the main section of a communication device in accordance with a second embodiment.

### DESCRIPTION OF THE PREFERRED EMBODIMENTS

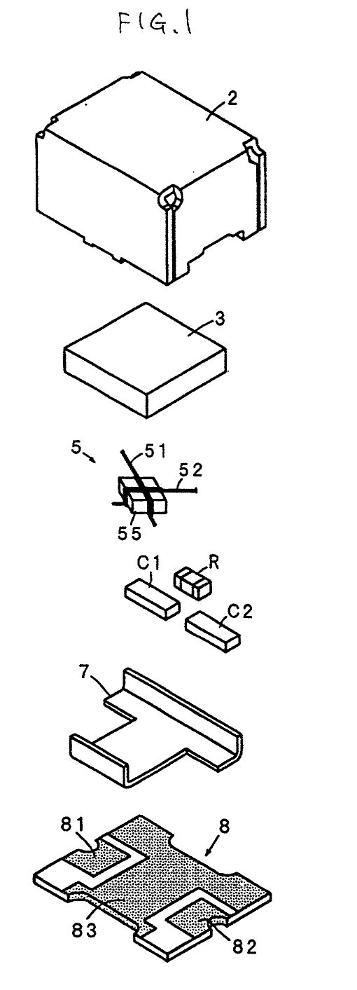

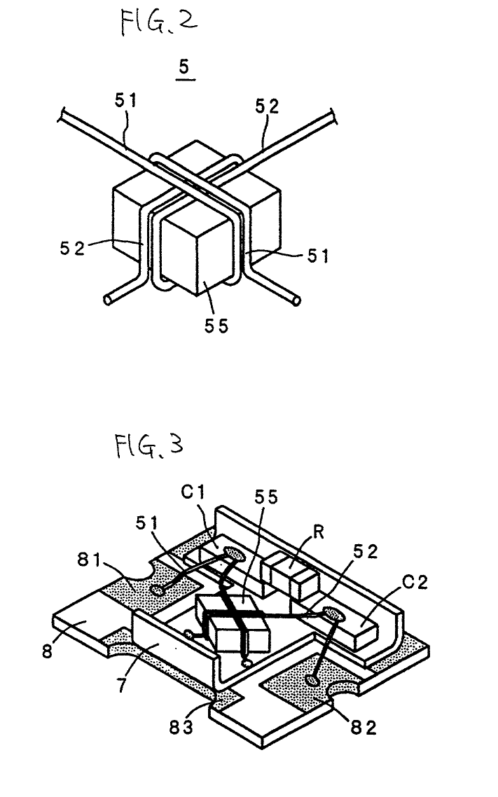

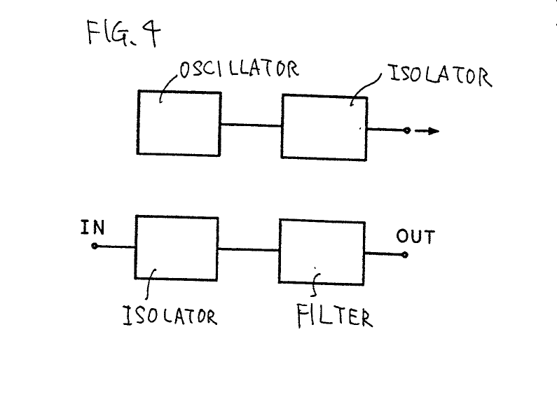

The construction of the nonreciprocal circuit device in accordance with the first embodiment of the present invention will be described with reference to FIGS. 1 through 3. FIG. 1 is an exploded perspective view showing this nonreciprocal circuit device. FIG. 2 is a perspective view showing the nonreciprocal circuit device of which the upper yoke and the permanent magnet have been removed. FIG. 3 is an enlarged perspective view showing a magnetic assembly.

The nonreciprocal circuit device in accordance with this embodiment has a construction wherein a permanent magnet 3 having a rectangular-parallelepiped plate shape is disposed on the inner surface of a box-shaped upper yoke 2 constituted of a magnetic metal such as mild iron; a magnetic closed circuit is formed of this upper yoke 2 and a substantially U-shaped lower yoke 7 likewise constituted of a magnetic metal; a magnetic assembly 5, chip capacitors C1 and C2, and a chip resistor R are provided in the yoke; a terminal substrate 8 is provided on the bottom surface of the lower yoke 7; and a DC magnetic field is applied to the magnetic assembly 5 by the permanent magnet 3.

As shown in FIG. 3, the magnetic assembly 5 is formed by winding two centeral conductors 51 and 52 around a plan-view rectangular magnetic body 55 so as to intersect each other at an angle of 90 degrees. The shape of each of both surfaces of the magnetic body 55 is rectangular or square. As these centeral conductors 51 and 52, metallic wires constituted of metallic material such as copper or silver are used, the metallic wires being coated with an insulative resin. As an insulative resin, polyester, polyimide, polyurethane, polyamide, polyesterimide, or the like is used.

The dimension of one side of the magnetic body 55 is 0.5 mm to 1.0 mm, and the thickness thereof is 0.3 mm to 0.5 mm is used. The cross-sectional diameter of each of the centeral conductors 51 and 52 is 0.05 mm to 0.10 mm are used. As a material of the metallic wires, copper or silver is used, which is inexpensive and high in the permittivity, but another metallic material such as gold may instead be employed. Also, the metallic wires are not limited to ones each having a circular cross-section, but band-shaped ones each having a rectangular cross-section may be used.

More specifically, in this embodiment, as the centeral conductors 51 and 52, insulation-coated metallic wires are used, and these metallic wires are wound around the magnetic body 55 so as to be arranged at least one time along both main surfaces of the magnetic body 55. FIG. 3 illustrates the state wherein each of the metallic wires is wound around the magnetic body 1.5 times.

The terminal substrate 8 has an input-terminal electrode 81, an output-terminal electrode 82, and a ground electrode 83 provided thereon. The input and output electrodes 81 and 82, and the ground electrode 83 are extended to the sides and the bottom surface of the terminal substrate 8. The nonreciprocal circuit device is mounted on a mounting-substrate (circuit substrate), in which the bottom surface of the terminal substrate 8 is used as a mounting surface.

As shown in FIG. 3, the lower yoke 7 is disposed on the terminal substrate 8; the magnetic assembly 5 and the chip capacitors C1 and C2, in which electrodes are provided on the top and bottom surfaces (in the figure) thereof, are disposed on the lower yoke 7; and the chip resistor R is disposed on the capacitors C1 and C2 so as to bridge the capacitors C1 and C2. The bottom surface of the lower yoke is soldered to the ground conductor 83 on the terminal substrate 8. The bottom-surface electrodes of the capacitors C1 and C2 are soldered to the lower yoke 7. The electrode of the chip resistor R is soldered to the top-surface electrodes of the capacitors C1 and C2. One end of each of the centeral conductors 51 and 52 is soldered to the lower yoke 7, the other end of the centeral conductor 51 is soldered to the input-terminal electrode 81 via the top-surface electrode of the capacitor C1, and the other end of the centeral conductor 52 is soldered to the output-terminal electrode 82 via the top-surface electrode of the capacitor C2. At this time, if a resin material such as polyesterimide is used as a coating material for the centeral conductors 51 and 52, the coating will be evaporated by the heating during soldering. This will eliminate the need for preliminarily removing the insulation coatings at soldered portions, which leads to a reduction in the number of manufacturing step.

By the above-described connection, a two-port type nonreciprocal circuit device is formed wherein the one end of each of the centeral conductors 51 and 52 is grounded; the other end of the centeral conductor 51 is connected to the input-terminal 81; the other end of the centeral conductor 52 is connected to the output-terminal 82, the capacitor C1 is connected between the input terminal 81 and the ground; the capacitor C2 is connected between the output terminal 82 and the ground; and the resistor R is connected between the input-terminal 81 and the output-terminal 82.

Then, by putting the box-shaped upper yoke 2 on which the permanent magnet 3 is mounted in advance, on the terminal substrate 8, and by soldering the upper yoke 2 and the lower yoke 7 together, the nonreciprocal circuit device is formed in its entirety. This yoke formed of the upper yoke 2 and the lower yoke 7 forms a magnetic closed circuit, and performs the function of an outer case for protecting inside members, as well as performs the function of an electric shielding member since the yoke is connected to the ground conductor 83.

As describe above, in the nonreciprocal circuit device in accordance with this embodiment, insulation-coated metallic wires are used as the centeral conductors 51 and 52, these wires are wound around the magnetic body 55, and thereby the inductance component of the centeral conductors 51 and 52 increases greater than conventional ones. The winding number of the centeral conductors 51 and 52 is set to be the number allowing a desired inductance component to be obtained. Thus, by changing the winding number of the centeral conductors, the desired inductance value can be easily obtained.

Therefore, even if a small-sized magnetic body 55 is used, the inductance component of the centeral conductors 51 and 52 can be increased, and hence capacitors C1 and C2 each having a small capacitance value, that is, a small size, can be used, which results in a reduction in the size of the overall nonreciprocal circuit device. For example, at an operation frequency of 800 MHz, when the centeral conductors each having a diameter of 0.05 mm are wound 3.5 times around a magnetic body having 0.7 mm long, 0.7 mm wide, and 0.3 mm thick, the inductance value thereof becomes substantially 19.8 nH, and the capacitance value required at this time for the capacitors becomes 2.0 pF. Herein, if a dielectric material having a permittivity of 110 and a thickness of 0.17 mm is used, the dimensions of each of the capacitors have 0.45 mm×0.75 mm, and the outer dimensions of the nonreciprocal circuit device having the above-described construction can be reduced to 3.5 mm square or less.

Also, since the centeral conductors 51 and 52 are insulation-coated, there is no need for extra insulators for insulating the centeral conductors to each other, the number of assembly steps for the magnetic assembly can be reduced. In addition, if the magnetic body 55 is formed as a rectangular-parallelepiped having a rectangular shape in plan view as described above, the centeral conductors 51 and 52 can be wound around the magnetic body 55 at an intersecting angle of 90 degrees with ease and reliability.

Furthermore, since the permanent magnet 3 formed as a rectangular-parallelepiped is used, a magnetic force can be efficiently applied to the magnetic body 55.

Meanwhile, the shape of each of the magnetic body 55 and permanent magnet are not limited to that in the first embodiment, but a polygonal shape in a plan view other than a rectangular shape in a plan view, or a circular shape in a plan view may instead be employed as a shape thereof. If a magnetic body having a polygonal shape in a plan view is used, the two centeral conductors can be wound at a desired intersecting angle with a high accuracy, by winding the centeral conductors orthogonally to the sides of the magnetic body. Also, the intersecting angle between the two centeral conductors are not restricted to 90 degrees, but may be set between 80 degrees and 100 degrees, as required. Moreover, the overall structure of the nonreciprocal circuit device is not restricted to that in the first embodiment. For example, a one-piece yoke may instead be employed without dividing the yoke, and as the terminal substrate, a box-shaped one may be adopted. Spacer members for holding members may also be provided.

In the above-described embodiments, descriptions have been made taking the two-port type nonreciprocal circuit device as an example, but the present invention can also be applied to a three-port type nonreciprocal circuit device.

Next, the construction of a communication device in accordance with a second embodiment will be described with reference to FIG. 4. Using the above-described nonreciprocal circuit device, for example, as shown in FIG. 4A, the nonreciprocal circuit device is provided at the oscillation output portion of an oscillator such as a VCO (voltage-controlled oscillator), whereby the reflected waves from the transmission circuit connected to the output portion of the nonreciprocal circuit device do not enter the oscillator. This enhances the oscillation stability of the oscillator. Also, as shown in FIG. 4B, the nonreciprocal circuit device is provided at the input portion of a filter for impedance matching. A constant impedance filter is thereby formed. The communication device is formed by providing such a circuit at the transmission or reception circuit portion.

By thus using the nonreciprocal circuit device in accordance with the present invention, a small-sized communication device having excellent characteristics can be achieved.

As is evident from the above description, in accordance with the nonreciprocal circuit device of the present invention, even if a small-sized magnetic body is used, the inductance component of the centeral conductors can be increased, and thereby the capacitors for providing a required characteristics can be reduced in the size, and hence the nonreciprocal circuit device can be miniaturized. Furthermore, since the inductance component can be increased, the insertion loss can be reduced over a wide band, and excellent isolation characteristics can be obtained. Moreover, since insulation-coated metallic wires are used, there is no need to separately provide insulators for electrically insulating the two centeral conductors, which leads to a cost reduction.

Moreover, by using a magnetic body having a polygonal plate shape, the cost thereof can be reduced, as well as the centeral conductors can be reliably positioned with a high accuracy, and a stable and excellent characteristics can be achieved. Also, by using a permanent magnet formed as a rectangular-parallelepiped, the cost thereof can be reduced, and also the magnetic force thereof can be efficiently applied to the magnetic body.

Furthermore, by employing the nonreciprocal circuit device in accordance with the present invention, a communication device which has a small-size and excellent characteristics can be achieved.

While the invention has been described in its preferred embodiments, obviously, numerous modifications and variations of the present invention are possible in light of the above teachings. It is therefore to be understood that within the scope of the appended claims, the invention may be practiced otherwise than as specifically described.

What is claimed is:

1. A nonreciprocal circuit device comprising:
a magnetic body which receives a DC magnetic field, said magnetic body including a plurality of centeral conductors provided in an electric insulation state;
wherein said plurality of centeral conductors are insulation-coated metallic wires; and
each of said metallic wires is wound around said magnetic body one or more times.

2. A nonreciprocal circuit device comprising:
a first centeral conductor one end of which is connected to an input terminal, and the other end of which is grounded;
a second centeral conductor which intersects said first conductor in an electric insulation state, one end of which is connected to an output terminal, and the other end of which is grounded;
a magnetic body including said first and second centeral conductors;
a permanent magnet for applying a static magnetic field substantially perpendicularly to the main surfaces of said magnetic body;
a first capacitor connected between said input terminal and a ground;
a second capacitor connected between said output terminal and the ground; and
a resistor connected between said input terminal and said output terminal,
wherein said first and second centeral conductors are insulation-coated metallic wires; and
said metallic wires are wound around said magnetic body one or more times.

3. A nonreciprocal circuit device as claimed in claim 2, wherein the material of said metallic wires is copper or silver.

4. A nonreciprocal circuit device as claimed in claim 2, wherein the intersecting angle between said first and second conductors is set to be within the range from 80 degrees to 100 degrees.

5. A nonreciprocal circuit device as claimed in claim 2, wherein said magnetic body has a polygonal shape in a plan view.

6. A nonreciprocal circuit device as claimed in claim 5, wherein said magnetic body has a rectangular shape in a plan view.

7. A nonreciprocal circuit device as claimed in claim 2 wherein said permanent magnet has a rectangular shape in a plan view.

8. A nonreciprocal circuit device as claimed in claim 2 further comprising:
a yoke accommodating said centeral conductors, said magnetic body, said permanent magnet, said capacitors, and said resistor, said yoke being disposed on a terminal substrate on which said input terminal, said output terminal, and a ground conductor are provided, and said yoke being connected to the ground conductor of the terminal substrate.

9. A nonreciprocal circuit device as claimed in claim 6, wherein the dimension of the long side of said magnetic body is not more than 1.0 mm.

10. A nonreciprocal circuit device as claimed in claim 2 wherein the outer shape of said nonreciprocal circuit device is a rectangular shape in a plan view;
the dimension of the long side of said nonreciprocal circuit device is not more than 3.5 mm.

11. A communication device comprising: a nonreciprocal circuit device as claimed in claim 2.
